(19) United States
(12) Patent Application Publication
(10) Pub. No.: US 2023/0082585 A1
(43) Pub. Date: Mar. 16, 2023

(54) Method for Inductive Surface Layer Hardening

(71) Applicant: SMS Elotherm GmbH, Remscheid (DE)

(72) Inventors: Stefan Dappen, Koeln (DE); Michael Dawidowicz, Solingen (DE)

(21) Appl. No.: 17/801,119

(22) PCT Filed: Feb. 22, 2021
(86) PCT No.: PCT/EP2021/054327

§ 371 Date: Aug. 19, 2022

(30) Foreign Application Priority Data
Feb. 20, 2020 (DE) 10 2020 104 476.3

(51) Int. Cl. C21D 9/40; C21D 1/667; C21D 1/10

(52) U.S. Cl. CPC C21D 9/40; C21D 1/667; C21D 1/10; C21D 2221/01

(57) ABSTRACT

The invention provides a method for the inductive surface layer hardening of a surface running around an annular component of a hardenable steel, which achieves uniform and uninterrupted hardening. For this purpose, a) an initial zone of the surface is surface layer hardened by it being brought to hardening temperature by means of an inductor and being quenched with a spray. b) The surface is then hardened by means of a stationarily arranged inductor arrangement and a movably arranged inductor arrangement, which each comprise a leading inductor for preheating the region of the surface covered by it, a trailing inductor offset in the direction of the initial zone for finish-heating the pre-heated region to the hardening temperature and a spray for quenching the finish-heated region, wherein the movable inductor arrangement is moved along the surface and at the same time the annular component rotates about an axis of rotation in order to move the surface to be hardened along the stationary inductor arrangement. The speed of the movable inductor arrangement along the surface is greater than its circumferential speed. c) An end zone of the surface is then hardened by the leading inductor of one of the inductor arrangements being moved temporarily in the direction of the end zone at an increased feed rate compared to its trailing inductor when the end zone is located at a certain distance from inductor arrangements such that an enlarged distance results between the leading inductor and the inductor trailing it and the leading inductor is located at the end zone by a time interval earlier, whose duration is equal to the duration required by the trailing inductor to cover the distance resulting between the trailing inductor and the leading inductor such that the at least one leading inductor arriving first at the end zone preheats the end zone until the trailing inductor is located at the end zone and finish-heats the end zone to hardening temperature. Finally, the finish-heated end zone is quenched by means of a spray.

### CROSS-REFERENCE TO RELATED APPLICATIONS

This application is the United States national phase of International Application No. PCT/EP2021/054327 filed Feb. 22, 2021, and claims priority to German Patent Application No. 10 2020 104 476.3 filed Feb. 20, 2020, the disclosures of which are hereby incorporated by reference in their entirety.

### BACKGROUND OF THE INVENTION

### Field of the Invention

The invention relates to a method for the inductive surface layer hardening of a surface which runs around an annular component consisting of a hardenable steel.

### Description of Related Art

“Methods for the inductive hardening of a surface layer” are methods in which the surface layer of the steel material which adjoins the surface to be hardened in each case and of which steel material the component bearing the surface in each case consists, is heated to hardening temperature by means of an electromagnetic field induced in the component and in which the section of the surface layer heated in this way is subsequently cooled down sufficiently quickly by applying a suitable quenching medium in order to generate hardening structures in the relevant surface section.

The technical and physical backgrounds of inductive surface layer hardening are explained in Data Sheet 236, “Heat treatment of steel—Surface layer hardening”, 2009 Edition, which is published by the Wirtschaftsvereinigung Stahl, Sohnstraße 65, 40237 Düsseldorf, and is available for download under the URL https://www.stahl-online.de/wp-content/uploads/2019/04/MB236_Waermebehandlung_von_Stahl_Randschichthaerten.pdf, Date retrieved, 6 Feb. 2020.

The annular components on which surfaces can be surface layer hardened by means of the method according to the invention are typically bearing rings for large-size rolling bearings or similar. Such bearing rings are used, for example, for the rolling bearings in which the rotors of large wind turbines are mounted or for rolling bearings in which tower cranes and the like are rotatably mounted about a vertical axis. The diameters of such bearings are typically in the range of 40-1000 cm.

Circumferential surfaces of such large annular components can be particularly effectively surface layer hardened by using two inductors, which are moved in synchronous, counter-rotating movements along the surface to be hardened. In this way, the inductors successively heat to hardening temperature the surface sections covered by the electromagnetic field they generate. The surface sections heated in this way are then quenched by spray jets, which are each applied by a spray tracking the inductors.

The advantages of this type of surface layer hardening are offset by the fact that the two or more inductors can only be approximated to one another up to a certain distance due to the installation space taken up by them. In this way, even if the inductors are arranged very closely adjacent at the beginning or end of the machining process, a zone remains on the workpiece in which only insufficient hardness is achieved, because the electromagnetic fields generated by the inductors do not directly reach the zone of the surface to be hardened present between the inductors or because only insufficient heating of this zone occurs due to mutual disturbances of the fields generated by the inductors. In practice, the initial zone of the surface to be hardened, over which the inductors are situated closely adjacent at the beginning of the hardening process, proves to be less problematic than the end zone, since during the heating of the initial zone, a previously heated surface section does not have to be quenched at the same time and sufficient time is therefore available to bring the region not directly covered by the electromagnetic fields of the inductors to the hardening temperature by means of heat migration.

However, without any special countermeasures and due to the structural conditions, a region remains in the end zone of the surface to be hardened, in which the inductors meet again after they have been moved along the ring sections assigned to them in each case, which is only insufficiently heated and therefore does not reach the hardness achieved over the remaining sections of the surface to be surface layer hardened. This only incompletely hardened region is also referred to in technical terms as “slip” and can lead to premature failure in practical use, in particular in applications in which the surface layer hardened surfaces are regularly loaded over their entire circumference. As a result, the slip region wears more quickly than the rest of the higher-hardened region of the surface layer hardened surface due to its lower hardness.

Various processes have been developed to enable the non-slip hardening of circumferential surfaces of large annular components.

A first example of such a method is known from EP 1 848 833 B1. In this method for manufacturing a bearing ring for large-size rolling bearings with at least one race with a hardened surface layer, at least two inductors are arranged at the beginning of the hardening over a common initial zone of the annular race to be hardened and they heat the opposite surface layer there to hardening temperature. The inductors are then moved along the race in the opposite direction to heat the intermediate zones of the annular race of the bearing ring, which each adjoin the initial zone. After the inductors, which are moved in opposite directions, have covered a short distance, sprays directed at the heated surface layers are switched on such that the relevant previously heated surface layers are quenched proceeding from the middle of the initial zone heated at the beginning. The inductors and with them the respectively assigned spray are then moved further on their ring halves until they meet again at an end zone opposite the starting point and again form a common heating zone there. Once the required hardening temperature has been reached in the end zone, both inductors are lifted vertically off the surface of the race to make space for the sprays, which are now directed towards the end zone, in order to quench them. In order to bring the end zone to hardening temperature reliably and quickly, the known method provides for an additional auxiliary inductor, which preheats the end zone already during the heating of the initial zone or the intermediate zones.

A further method of the type in question here is known from EP 2 310 543 B1. This method is based on the older method described in EP 1 848 833 B1 and envisages the auxiliary inductor, which is used in the method known from EP 1 848 833 B1 for preheating the end zone, being moved, for example in an oscillating or circular manner, to homogenize the heating in an additional degree of freedom compared to the movements already provided for in the older method.

A third method for hardening a workpiece plotting a closed curved line, such as a bearing or toothed ring, is known from EP 1 977 020 B1. In this known method, at least two inductors are placed on the workpiece in a starting region in a first work step, wherein the inductors adopt start positions closely adjacent to one another which delimit a starting zone between them. The starting zone is then heated to hardening temperature by means of at least one of the inductors and subsequently quenched. The inductors are then moved along the workpiece proceeding from their respective start position, wherein the direction of movement of one inductor is directed opposite to the direction of movement of the other inductor and wherein the sections of the workpiece located in the operating region of the inductors are heated to hardening temperature and subsequently quenched. The opposite movements of the inductors are continued until the inductors have reached an end position in which they are arranged closely adjacent to the respectively other inductor in each case. An end zone is now enclosed between the then reached end positions of the two inductors. In order to also bring this end zone to hardening temperature, the inductors are moved together in the direction of one of the directions of movement of the inductors and the end zone is heated to hardening temperature by the inductor that has already been previously moved in this direction of movement. In this way, the end zone is completely traversed by at least one of the inductors and brought uniformly to hardening temperature.

Finally, a method and a device for the inductive hardening of an annular surface of a circular component are known from EP 2 542 707 B1, in the case of which four inductors are arranged grouped into two inductor pairs on the annular surface to be hardened, wherein a spray is assigned to each inductor pair and at the beginning of the heating, the sprays are arranged closely adjacent to one another. The inductors of the inductor pairs and the assigned sprays are also arranged directly next to each other. After being switched on, the inductor-spray combinations aligned in such a way over an initial zone of the race to be hardened are moved in opposite circumferential directions along the intermediate section, assigned to them in each case, of the race to be hardened such that the surface sections previously heated to hardening temperature by means of the inductor pairs are subsequently immediately quenched in order to form hardening structures on the surface layer of the race. The inductor pairs continue their opposing movement until the respectively leading inductors of the inductor pairs meet over an end zone of the race. When the end zone is reached, the leading inductors are removed from the race surface in order to make space for the trailing inductors of the inductor pairs. These trailing inductors continue to be moved in their respective previous circumferential direction until they also meet above the end zone and the end zone is also heated to hardening temperature by the two trailing inductors. After the trailing inductors have also been moved successively or simultaneously away from the end zone of the surface to be hardened together with the spray assigned to each of them, the end zone is also quenched by a further spray in order to achieve hardening structures there as well.

### SUMMARY OF THE INVENTION

Against the background of the prior art explained above, the object has emerged to provide a method optimized in terms of the time required, which makes it possible to surface layer harden a circumferential surface of an annular component optimally uniformly and without interruptions.

The invention has achieved this object by means of a method in which at least the work steps as described herein are completed.

It goes without saying that a person skilled in the art, in carrying out the method according to the invention and its variants and expansion options explained here, supplements the work steps not explicitly mentioned in the present case, which he knows from his practical experience are regularly applied when carrying out such methods.

Advantageous configurations of the invention are defined in the dependent claims and, like the general concept of the invention, are explained in detail in the following.

The method according to the invention is used for the inductive surface layer hardening of a surface running around an annular component consisting of a hardenable steel, in particular a bearing ring of a large-size rolling bearing, which has an initial zone, which is surface layer hardened at the beginning, and an end zone, which is surface layer hardened at the end. To this end, a method according to the invention comprises the following work steps:
a) surface layer hardening of the initial zone by the initial zone being brought to hardening temperature by means of at least one inductor and being quenched by means of at least one spray, which directs a jet of a quenching medium onto the heated initial zone;
b) successive surface layer hardening of the surface, to be surface layer hardened, of the annular component subsequent to the surface layer hardening of the initial zone
   by means of two inductor arrangements, which each comprise a leading inductor, which causes preheating of the region, respectively covered by it, of the surface to be surface layer hardened, a trailing inductor, which is arranged offset with respect to the leading inductor in the direction of the initial zone and causes finish-heating of the region previously preheated by the leading inductor to hardening temperature, as well as a spray, which quenches the region, respectively previously finish-heated by the trailing inductor, of the surface to be surface layer hardened with a jet of a quenching medium,
   wherein the one inductor arrangement is arranged stationary,
   the other inductor arrangement is designed to be movable and is moved along the surface to be surface layer hardened for the purpose of surface layer hardening, and
   simultaneously the annular component rotates about an axis of rotation in order to move the surface to be surface layer hardened along the stationary inductor arrangement, wherein the speed at which the movable inductor arrangement is moved along the surface to be surface layer hardened is greater than the circumferential speed of the surface, to be surface layer hardened, of the annular component;
c) hardening of the end zone by the leading inductor of at least one of the inductor arrangements being moved at least temporarily in the direction of the end zone at an increased feed rate compared to the trailing inductor of this inductor arrangement when the end zone is located at a certain distance from the inductor arrangements such that an enlarged distance results between the relevant leading inductor and the trailing inductor assigned to it and the leading inductor is located at the end zone by a time interval earlier, whose duration is equal to the duration required by the trailing inductor to cover the distance resulting between the trailing inductor and the leading inductor such that the at least one leading inductor arriving first at the end zone preheats the end zone until the trailing inductor of its inductor arrangement is located at the end zone and finish-heats the end zone to hardening temperature, wherein the end zone finish-heated to hardening temperature is then quenched by means of a spray.

In this case, between the initial zone and the end zone of the surface to be hardened are located two intermediate zones, of which the first intermediate zone is connected to the initial zone in a first circumferential direction and of which the second intermediate zone is connected to the initial zone in a second circumferential direction opposite to the first circumferential direction, such that the end zone extends between the ends of the intermediate zones facing away from the initial zone. These intermediate zones are covered during the surface layer hardening by the inductor arrangements used according to the invention as a result of the movement carried out by the movable inductor arrangement and the simultaneous rotation of the annular component.

In the case of the method according to the invention, the end zone of the surface to be surface layer hardened is preheated by means of at least one of the inductors, which are already involved in the surface layer hardening of the intermediate zones of the surface carried out in circulation.

As a result of its higher feed rate starting from a certain approach to the end zone, the leading inductor moving towards the end zone reaches the end zone of the surface to be hardened more quickly such that it can already preheat it as long as the trailing inductor of its inductor arrangement is still on the way to the end zone or the end zone is on the way to the respective trailing inductor. Once the trailing inductor has arrived at the end zone or the end zone has arrived at the trailing conductor, the leading inductor is moved away from the end zone and the trailing inductor takes its place in order to finish-heat the end zone to hardening temperature. Once the end zone has reached the hardening temperature, the trailing inductor can also be removed from the end zone and the end zone is quenched by means of the spray provided for this purpose. Alternatively, the end zone can also be moved to a spray to perform the quenching.

The feed rate, at which the moving inductor arrangement is moved along the circumferential surface to be hardened, which is also moved at a circumferential speed, is greater than the circumferential speed of the circumferential surface such that the moving inductor arrangement leads the circumferential surface. The movement of the movable inductor arrangement along the rotating circumferential surface to be surface layer hardened and the direction of rotation of the circumferential surface to be surface layer hardened are unidirectional accordingly.

The leading inductor of the moving inductor arrangement is thereby arranged in the feed direction in front of the trailing inductor, behind which, in relation to the feed direction, the spray of the inductor arrangement is positioned. In this way, a new unhardened region of the circumferential surface to be surface layer hardened continuously enters the operating region of the electromagnetic field induced by the leading inductor of the moving inductor arrangement, is pre-heated as a result and then enters the operating region of the electromagnetic field induced by the trailing inductor of the moving inductor arrangement without interruption. Through this field, the respectively covered zone of the surface to be surface layer hardened is finish-heated to hardening temperature in order to then be quenched by the spray of the moving inductor arrangement.

In the case of the stationary inductor arrangement, the leading inductor is arranged offset with respect to the trailing inductor opposite the direction of rotation of the circumferential surface of the annular component such that as a result of the rotational movement of the annular component, a respectively unhardened region of the surface to be surface layer hardened (i.e. a region of the intermediate zones present between the initial and end zone) continuously enters the operating region of the electromagnetic field of the leading inductor (“preheating inductor”) and then the operating region of the electromagnetic field of the trailing inductor (“finish-heating inductor”) of the stationary inductor arrangement in order to be subsequently quenched by the spray assigned to the stationary inductor arrangement, which is arranged behind the trailing inductor of the stationary inductor arrangement in relation to the direction of rotation of the annular component.

Symmetrical hardening of the intermediate zones can be achieved in that the feed rate of the fixed inductor arrangement is maintained constantly equal to twice the circumferential speed of the circumferential surface to be hardened of the annular component. After reaching its distance from the end zone provided as the starting point for its acceleration, the leading inductor of the moving inductor arrangement can continue to be moved in the direction of the end zone at an increased speed compared to the feed rate of the moving inductor arrangement maintained until then, while the trailing inductor and the spray of the moving inductor arrangement are still moved at the previously maintained feed rate.

Alternatively or in addition to the accelerated feed movement of the leading inductor of the moving inductor arrangement, which is used upon reaching the distance from the end zone respectively intended therefor, the leading inductor of the stationary inductor arrangement can also be moved towards the end zone, in this case opposite the direction of rotation of the circumferential surface to be hardened, as soon as the end zone is located at the distance from the leading inductor intended for the start of this movement.

In the event that both the leading inductor of the moving inductor arrangement and the leading inductor of the stationary inductor arrangement are moved towards the end zone, the speed at which the leading inductors move towards each other is optimally the same. In this way, the leading inductors meet above the end zone in order to then heat it together. For this purpose, the direction of movement of the leading inductor of the stationary inductor arrangement is reversed after reaching the end zone and the two leading inductors of the stationary and movable inductor arrangement are advanced together at a speed which is set such that a relative movement no longer takes place between the end zone and the leading inductors, i.e. the leading inductors remain constantly above the end zone of the circumferential surface to be hardened and in this way uniformly preheat it together.

Since the rotation of the annular component, on the one hand, and the feed movement of the trailing inductor and of the spray of the moving inductor arrangement, on the other hand, are thereby maintained constant, the end zone of the surface to be hardened and with it the leading inductors approach the trailing inductor of the stationary inductor arrangement and simultaneously, from the opposite side, the trailing inductor of the moving inductor arrangement approaches the end zone. Once the trailing inductor of the moving inductor arrangement has reached the end zone and the end zone has reached the trailing inductor of the stationary inductor arrangement that remains stationary, the respective leading inductor still located above the end zone can be moved away in order to make space for the trailing inductors. If two leading inductors were previously positioned above the end zone, the movement of the relevant leading inductors away can take place one after the other such that the leading inductor respectively still remaining above the end zone can continue to heat the end zone until it also has to be moved away in order to make space for the subsequent trailing inductor of the movable inductor arrangement or space for the end zone to move into the operating region of the trailing inductor of the stationary inductor arrangement.

In this case, the finish-heating can also be carried out by the trailing inductors of the inductor arrangements together or by respectively one of the relevant trailing inductors.

In principle, it may be sufficient for the sprays for quenching used according to the invention to direct a single jet of the quenching medium on the zone to be quenched in each case, provided that this jet is sufficiently strong and the applied liquid volume is sufficiently large to remove heat from the zone to be hardened at the required speed. In practice, sprays, which simultaneously apply a plurality of individual jets, have proven themselves for this purpose in order to safely and completely apply to the zone to be quenched a quantity of quenching medium that is sufficient to remove the heat.

One advantage of the preheating and/or finish-heating of the end zone with only one inductor in each case is that mutual disturbances of the respectively effective electromagnetic field, which can occur if two inductors closely adjacent heat a zone together, do not occur. Special measures to avoid these disturbances are therefore not necessary. In addition, the use of a single inductor for the preheating and/or finish-heating of the end zone allows precise control of the heat introduced into the end zone such that, for example, a correspondingly precisely designed hardness profile can be achieved in the hardened surface layer.

As an alternative to the variants explained above, in which the preheating and finish-heating of the end zone has only been carried out with one inductor in each case, it is also possible, in cases in which for example the heating to hardening temperature is to be achieved as quickly as possible, to carry out the preheating and/or finish-heating in each case by means of two inductors together.

In practice, the difference in speed between the leading inductor respectively moved at increased feed rate and the trailing inductor assigned to it or between the circumferential surface to be hardened of the annular component and the respectively leading inductor is, for example, set such that the duration available for the preheating of the end zone by means of the leading inductor is 1-10 s.

In terms of value, suitable increased feed rates of the leading inductors are, for example, in practice in the range of 240 mm/min-1800 mm/min, whereas the feed rates at which the trailing inductors and temporarily also the leading inductors are moved along the intermediate zones can be in the range of 180 mm/min-1200 mm/min. It goes without saying that the respective speed is selected within the ranges specified for the increased feed rate of the leading inductors and the feed rate of the trailing inductors such that the increased feed rate of the leading inductors is higher than the speed at which the trailing inductors are moved.

In practice, the distance measured proceeding from the start position from which the faster feed movement of the respectively leading inductor starts to the beginning of the end zone in the direction of the movement of the leading inductor can be 40-300 mm.

In order to ensure that the respective leading inductor also generates sufficient heat in the regions covered by it during the phase of its fast movement, it may be expedient for the electrical power of the inductor leading at increased feed rate to be increased compared to the electrical power with which the relevant leading inductor is operated as long as it is moved at the same feed rate as the trailing inductor of its inductor arrangement. It may also be expedient to adjust the power of the respective trailing inductor if the leading inductor assigned to it is moved at an increased feed rate in order to ensure a heat input sufficient for heating to hardening temperature.

Even when heating the initial zone, it may be advantageous with regard to the targeted setting of a certain hardness profile if only one inductor is used. To this end, according to a further variant of the method according to the invention, in work step a), the heating of the initial zone to hardening temperature can practically be carried out by one inductor of one of the inductor arrangements. This results in a movement sequence of the inductors involved that is easy to implement in practice if the inductor used to heat the initial zone is a trailing inductor of one of the inductor arrangements provided according to the invention. In order to make space for the use of the spray in this case after heating the initial zone to hardening temperature, the trailing inductor used to heat the initial zone, after the initial zone is heated to hardening temperature, in particular suddenly, can be moved in the direction of the starting region of the intermediate zone assigned to its inductor arrangement such that the jet of the spray provided for quenching the initial zone can then be directed to the initial zone in the space freed up by the inductor moving away.

The spray respectively used for quenching the initial zone or the end zone can be a spray of one of the inductor arrangements. For this purpose, it can be provided that at least the spray used for this purpose can be moved independently of the inductors such that, in order to quench the initial zone, it can be moved from its spatial assignment to the inductors during normal hardening operation to an operating position in which its spray jet optimally meets the initial zone to be quenched.

However, with a view to optimizing the transition between the hardening of the initial zone and the hardening of the intermediate zones adjoining it, it may also be favourable if a separate spray is provided for quenching the initial zone, whose jet and power are specially adapted to the conditions prevailing in the region of the initial zone.

Similarly, at least one of the sprays carried with the inductor arrangements can be used for quenching the end zone. For this purpose, it can also be provided that the spray can be moved independently of the inductors of the respective inductor arrangement such that, in order to quench the end zone, it can be moved from its spatial assignment to the inductors of the respective inductor arrangement into an operating position in which its spray jet optimally meets the end zone to be quenched.

Alternatively, however, it is also possible here to achieve an optimized quenching result with minimized effort for the adjustment of the sprays of the inductor arrangements by using an additional spray to quench the end zone, which is independent of the sprays of the inductor arrangements and is located in a waiting position during the heating of the end zone.

### BRIEF DESCRIPTION OF THE DRAWINGS

The invention is explained in more detail below on the basis of a drawing representing an exemplary embodiment,

FIGS. 1-9b each show a device for surface layer hardening in different phases of the method according to the invention schematically and not to scale in plan view.

### DESCRIPTION OF THE INVENTION

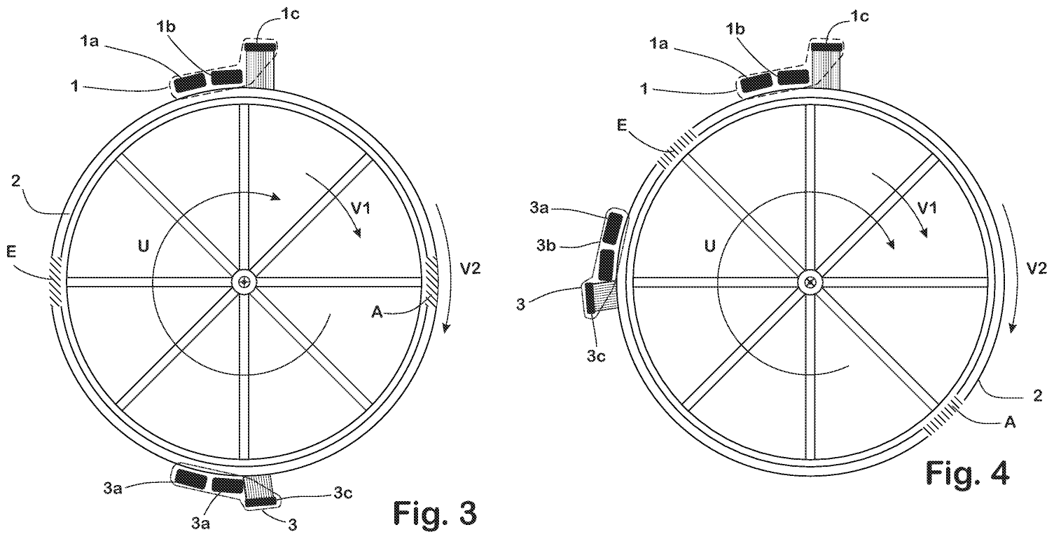

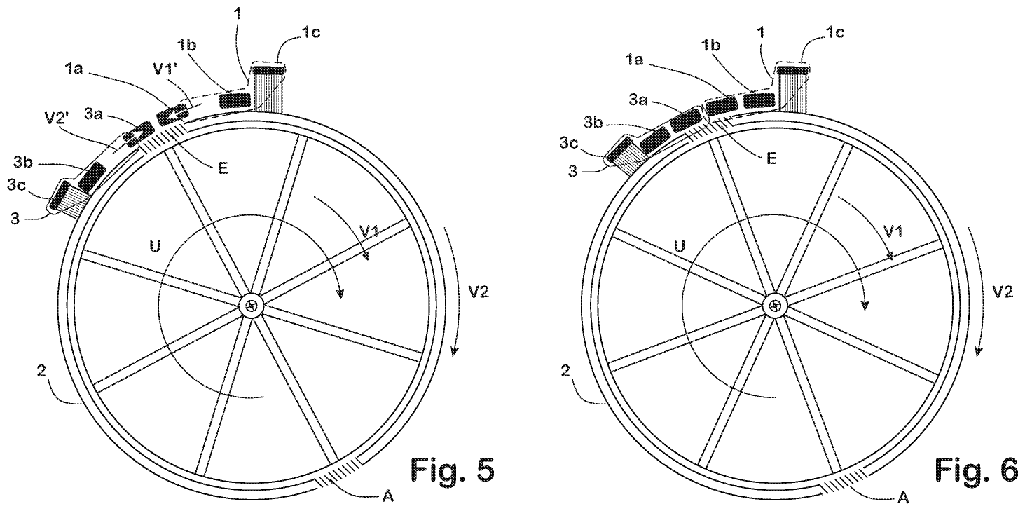

The device shown in FIGS. 1-9b is used for the surface layer hardening of a circumferential surface 2a of a bearing ring 2. It comprises an inductor arrangement 1, which is arranged stationary and which has a preheating inductor 1a, a finish-heating inductor 1b and a spray 1c. The preheating inductor 1a is arranged in a circumferential direction U in front of the finish-heating inductor 1b at the circumferential surface 2a to be hardened of the bearing ring 2. The finish-heating inductor 1b, which is also arranged closely adjacent to the circumferential surface 2a, is in turn positioned in the circumferential direction U in front of the spray 1c, which is arranged offset outwards in the radial direction with respect to the circumferential surface 2a compared to the inductors 1a, 1b.

In addition, the device has a movable second inductor arrangement 3, which can be moved along the bearing ring 2 in the circumferential direction U. The second inductor arrangement 3 comprises a preheating inductor 3a, a finish-heating inductor 3b arranged behind the preheating inductor 3a in the circumferential direction U and a spray 3c arranged behind the finish-heating inductor 3b in the circumferential direction U. The spray 3c is positioned offset outwards in the radial direction with respect to the circumferential surface 2a of the bearing ring 2 such that, in the start position in which the movable inductor arrangement 3 is located in close proximity to the stationary inductor arrangement 1 (see FIG. 1), said spray is arranged behind the finish-heating inductor 1b of the stationary inductor arrangement 1 in relation to the circumferential surface 2a, but can be moved along in front of the spray 1c of the stationary inductor arrangement 1 in relation to the circumferential surface 2a.

The bearing ring 2 aligned horizontally during the surface layer hardening is held in a workpiece holder 4 which can move it in a rotating manner about its vertically aligned central axis X in the circumferential direction U at a circumferential speed V1.

In the start position, the finish-heating inductor 3b of the movable inductor arrangement 3 is positioned in the circumferential direction U directly next to the finish-heating inductor 1b of the stationary inductor arrangement 1. The spray 1c of the stationary inductor arrangement 1 is located in relation to the circumferential surface 2a offset outwards in the radial direction behind the finish-heating inductor 3b. The bearing ring 2 stands still or is operated in an oscillating manner in a small angular range in order to homogenize the heat input when heating the initial zone A of the circumferential surface 2a to be hardened. The inductors 1a, 1b of the stationary inductor arrangement 1 and 3a, 3b of the movable inductor arrangement 3 now together heat the initial zone A (FIG. 1).

As soon as the hardening temperature is reached in the initial zone A, the bearing ring 2 is rotated about the axis X in the circumferential direction U such that the circumferential surface 2a runs around the axis X at a circumferential speed V1. The spray 1c of the stationary inductor unit 1 is switched on and quenches the initial zone A moving along it.

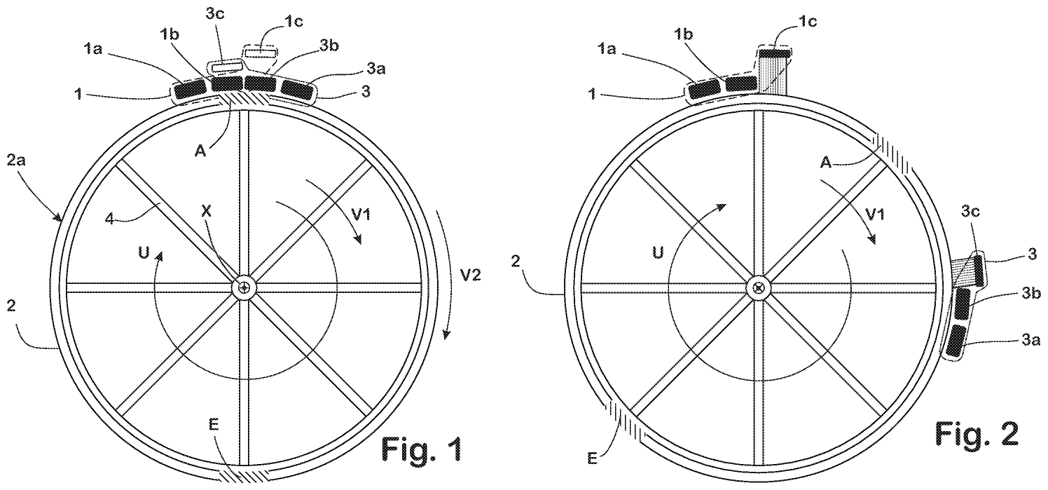

At the same time, the preheating inductors 1a, 3a of the stationary and of the movable inductor units 1, 3 are also switched on and the movable inductor unit 3 is moved at a speed V2 in the circumferential direction U along the circumferential surface 2a of the bearing ring 2. The speed V2 is twice the circumferential speed V1 (V2=2×V1). The spray 3c of the movable inductor arrangement 3 is also switched on as soon as it has passed the finish-heating inductor 1b of the stationary inductor arrangement 1 (FIG. 2).

During the movement along the circumferential surface 2a, the zone of the circumferential surface 2a respectively located in the operating region of the inductor unit 3 is successively hardened and quenched. In this case, the preheating inductor 3a causes preheating and the finish-heating inductor 3b causes finish-heating of the respective zone to hardening temperature, while the spray 3c quenches the zone heated to hardening temperature in order to generate hardening structures in the surface layer adjoining the circumferential surface 2a.

At the same time, the preheating inductor 1a of the stationary inductor arrangement 1 heats the zone of the circumferential surface 2a moved along it, which is then finish-heated by the finish-heating inductor 1b of the stationary inductor arrangement 1 in order to be subsequently quenched by the spray 1c of the stationary inductor arrangement 1. Due to the feed rate V2 of the movable inductor arrangement 3 being twice the circumferential speed V1, the relative speed between the inductor arrangement 3 and the circumferential surface 2 is the same as the circumferential speed V1. Accordingly, the movable inductor arrangement 3 moves at the same speed towards the end zone E of the circumferential surface 2a as the end zone E towards the stationary inductor arrangement 1 (FIGS. 2-4).

The successive hardening of the circumferential surface 2a is continued until the end zone E of the circumferential surface 2a has approached the preheating inductor 1a of the stationary inductor arrangement 1 at a certain distance. From this point on, the preheating inductor 3a of the movable inductor arrangement 3 is moved at an additionally increased feed rate V2′ compared to the feed rate V2 so as to lead the finish-heating inductor 3b of the movable inductor arrangement 3 in the direction of the end zone E. At the same time, the preheating inductor 1a of the stationary inductor arrangement 1 is moved towards the end zone E in a direction opposite the movement of the preheating inductor 3a and opposite the rotational movement of the bearing ring 2 at a speed V1′ which has the same value as the speed V2′. The finish-heating inductor 3b and the spray 3c as well as the bearing ring 2 continue to be moved unchanged during this time. In this way, the preheating inductors 1a, 3a meet above the end zone E at a position situated exactly between the finish-heating inductors 3b and 1b (FIG. 5).

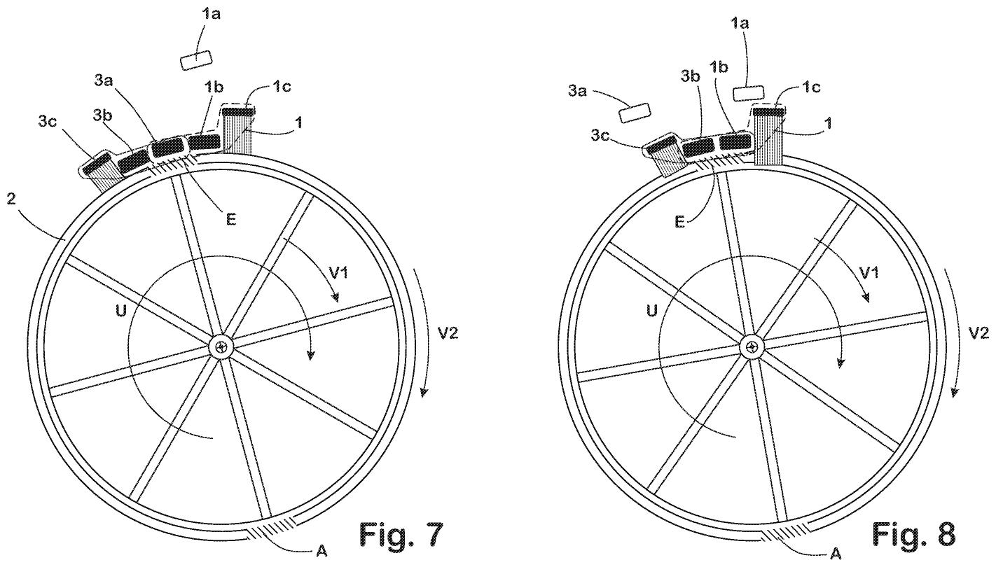

Once this position is reached, both preheating inductors 1a, 3a are moved together in the direction of the stationary finish-heating inductor 1b at a feed rate that is set such that a relative movement no longer takes place between the preheating inductors 1a, 3a and the end zone E, while the finish-heating inductor 3b and the spray 3c as well as the bearing ring 2 continue to be moved unchanged until the inductor 1a is back in its original stationary position. During this phase, the end zone E is preheated together by the preheating inductors 1a, 3a (FIG. 6).

The preheating inductor 3a of the movable inductor arrangement 3 is now switched off and moved to a waiting position remote from the circumferential surface 2a. The preheating inductor 3a is moved further at the speed V2′ in the direction of the stationary finish-heating inductor 1b, while the finish-heating inductor 3b and the spray 3c as well as the bearing ring 2 continue to be moved unchanged until the preheating inductor 3a has approached the finish-heating inductor 3b (FIG. 7).

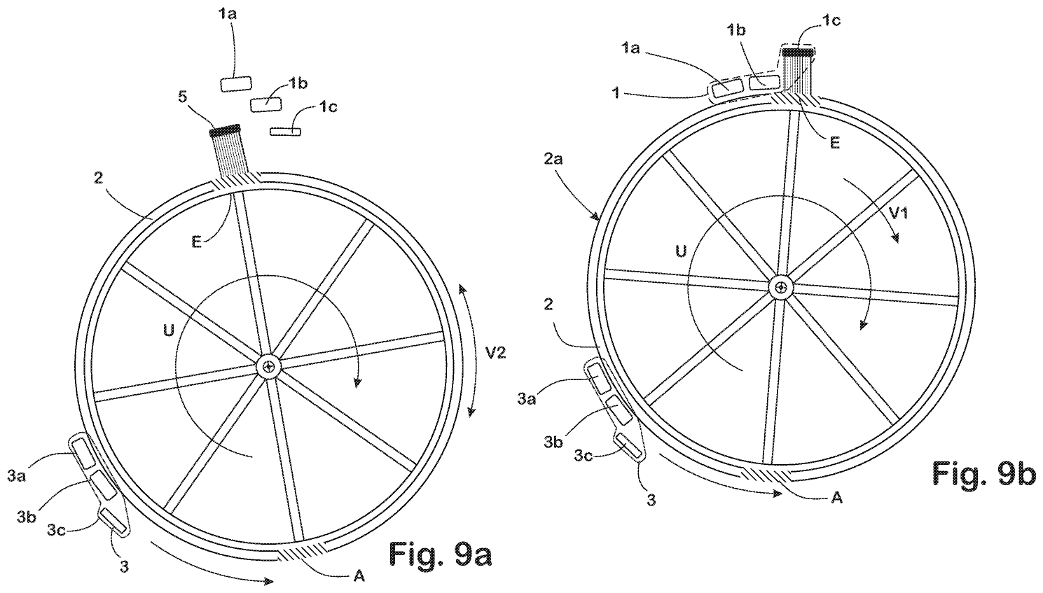

The preheating inductor 3a is now also switched off and moved into a waiting position, while the movable finish-heating inductor 3b is moved further with the spray 3c at the speed V2 in the circumferential direction U towards the stationary finish-heating inductor 1b, while the bearing ring 2 continues to move at the circumferential speed V1 until the moving finish-heating inductor 3b is in a position directly adjacent to the stationary finish-heating inductor 1b. The movement of the bearing ring 2 is now stopped and the finish-heating of the end zone E, which is now exactly below the finish-heating inductors 1b, 3b, is carried out together by the finish-heating inductors 1b, 3b (FIG. 8).

Alternatively, it would also be possible here to switch off both preheating inductors 1a, 3a and bring them into the waiting position as soon as they have approached one another, and then to continue the movements of bearing ring 2 and movable finish-heating inductor 3b and spray 3c until the finish-heating inductor 3b has reached its position next-adjacent to the finish-heating inductor 1b and situated above the end zone E.

If the hardening temperature is reached in the end zone E, according to a first variant, the finish-heating inductors 1b, 3b are pivoted away from the end zone E and the quenching is carried out by means of an additional spray 5 (FIG. 9a) or, according to a second variant, the bearing ring 2 rotates at fast speed in the circumferential direction U until the end zone E is arranged under the stationary spray 1c, which then performs the quenching (FIG. 9b).

The invention thus provides a method for the inductive surface layer hardening of a surface 2a running around an annular component of a hardenable steel, which achieves uniform and uninterrupted hardening. For this purpose, an initial zone A of the surface 2a is surface layer hardened by it being brought to hardening temperature by means of an inductor 1a, 1b, 3a, 3b and being quenched with a spray 1c, 3c. The surface 2a is then hardened by means of a stationarily arranged inductor arrangement 1 and a movably arranged inductor arrangement 1, 3, which each comprise a leading inductor 1a, 3a for preheating the region of the surface 2a covered by it, a trailing inductor 1b, 3b offset in the direction of the initial zone A for finish-heating the pre-heated region to the hardening temperature and a spray 1c, 3c for quenching the finish-heated region, wherein the movable inductor arrangement 3 is moved along the surface 2a and at the same time the annular component 2 rotates about an axis of rotation X in order to move the surface 2a to be hardened along the stationary inductor arrangement 1, wherein the speed V2 of the movable inductor arrangement 3 along the surface 2a is greater than its circumferential speed V1. An end zone E of the surface 2a is then hardened by the leading inductor 1a, 3a of one of the inductor arrangements 1, 3 being moved temporarily in the direction of the end zone E at an increased feed rate V1′, V2′ compared to its trailing inductor 1b, 3b when the end zone E is located at a certain distance from the inductor arrangements 1, 3 such that an enlarged distance results between the leading inductor 1a, 3a and the inductor 1b, 3b trailing it and the leading inductor 1a, 3a is located at the end zone E by a time interval earlier, whose duration is equal to the duration required by the trailing inductor 1b, 3b to cover the distance resulting between the trailing inductor and the leading inductor such that the at least one leading inductor 1a, 3a arriving first at the end zone E preheats the end zone E until the trailing inductor 1b, 3b is located at the end zone E and finish-heats the end zone E to hardening temperature. Finally, the finish-heated end zone E is quenched by means of a spray 1c, 3c, 5.

### REFERENCE NUMERALS

1 Stationary inductor arrangement
1a Preheating inductor of the inductor arrangement
1b Finish-heating inductor of the inductor arrangement
1c Spray of the inductor arrangement
2a Circumferential surface of the bearing ring 2 to be hardened
2 Bearing ring (=annular component)
3 Movable inductor arrangement
3a Preheating inductor of the inductor arrangement 3
3b Finish-heating inductor of the inductor arrangement 3
3c Spray of the inductor arrangement 3
4 Workpiece holder
5 Additional spray
A Initial zone of the circumferential surface 2a to be hardened
E End zone of the circumferential surface 2a to be hardened
U Circumferential direction
V1 Circumferential speed of the bearing ring 2
V1′ Feed rate of the preheating inductor 1a
V2 Movement speed of the movable inductor arrangement 3
V2′ Increased feed rate of the preheating inductor 3a
X Vertically aligned central axis of the workpiece holder 4

1. A method for the inductive surface layer hardening of a surface running around an annular component consisting of a hardenable steel, which has an initial zone, which is surface layer hardened at the beginning, and an end zone, which is surface layer hardened at the end, comprising the following work steps:
a) surface layer hardening of the initial zone by the initial zone being brought to hardening temperature by means of at least one inductor and being quenched by means of at least one spray, which directs a jet of a quenching medium onto the heated initial zone,
b) successive surface layer hardening of the surface, to be surface layer hardened, of the annular component subsequent to the surface layer hardening of the initial zone
by means of two inductor arrangements, which each comprise a leading inductor, which causes preheating of the region, respectively covered by it, of the surface be surface layer hardened, a trailing inductor, which is arranged offset with respect to the leading inductor in the direction of the initial zone and causes finish-heating of the region previously preheated by the leading inductor to hardening temperature, as well as a spray, which quenches the region, respectively previously finish-heated by the trailing inductor, of the surface to be surface layer hardened with a jet of a quenching medium,
wherein the one inductor arrangement is arranged stationary,
the other inductor arrangement is designed to be movable and is moved along the surface to be surface layer hardened for the purpose of surface layer hardening, and
simultaneously the annular component rotates about an axis of rotation in order to move the surface to be surface layer hardened along the stationary inductor arrangement, wherein the speed at which the movable inductor arrangement moved along the surface to be surface layer hardened is greater than the circumferential speed of the surface, to be surface layer hardened, of the annular component;
c) hardening of the end zone by the leading inductor of at least one of the inductor arrangements being moved at least temporarily in the direction of the end zone at an increased feed rate compared to the trailing inductor of this inductor arrangement when the end zone located at a certain distance from the inductor arrangements such that an enlarged distance results between the relevant leading inductor and the trailing inductor assigned to it and the leading inductor is located at the end zone by a time interval earlier, whose duration is equal to the duration required by the trailing inductor to cover the distance previously resulting between the trailing inductor and the leading inductor such that the at least one leading inductor arriving first at the end zone preheats the end zone until the trailing inductor of its inductor arrangement is located at the end zone and finish-heats the end zone to hardening temperature, wherein the end zone finish-heated to hardening temperature is then quenched by means of a spray.

2. The method according to claim 1, wherein the speed at which the movable inductor arrangement is moved along the surface to be surface layer hardened is twice the circumferential speed of the surface, to be surface layer hardened, of the annular component.

3. The method according to claim 1, wherein the leading inductor of the movable inductor arrangement is moved in the direction of the end zone at increased feed rate when the end zone is located at a certain distance from the inductor arrangements.

4. The method according to claim 1, wherein the leading inductor of the stationary inductor arrangement is moved towards the end zone opposite the direction of rotation of the surface to be hardened when the end zone is located at a certain distance from the inductor arrangements.

5. The method according to claim 3, wherein the leading inductors of the movable and of the stationary inductor arrangement are simultaneously moved towards the end zone when the end zone is located at a certain distance from the inductor arrangements.

6. The method according to claim 5, wherein the feed rate of the leading inductors has the same value.

7. The method according to claim 1, wherein the end zone is quenched by one of the sprays of at least one of the inductor arrangements after being finish-heated to the hardening temperature.

8. The method according to claim 1, wherein the end zone is quenched by a spray, which is provided separately and is independent of the inductor arrangements, after being finish-heated to the hardening temperature.

9. The method according to claim 1, wherein the electrical power of the inductor leading at increased feed rate is increased compared to the electrical power with which the relevant leading inductor is operated as long as it is moved at the same feed rate as the trailing inductor of its inductor arrangement.
